(19) United States
(12) Patent Application Publication
(10) Pub. No.: US 2011/0044226 A1
(43) Pub. Date: Feb. 24, 2011

(54) SELECTIVELY GENERATING MULTICAST FLOW IDENTIFIERS AND SELECTIVELY OBTAINING SESSION PARAMETERS FOR A MULTICAST COMMUNICATION SESSION

(75) Inventors: Bongyong Song, San Diego, CA (US); Arvind V. Santhanam, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/706,516

(22) Filed: Feb. 16, 2010

Related U.S. Application Data
(63) Continuation-in-part of application No. 12/235,450, filed on Sep. 22, 2008.
(60) Provisional application No. 60/974,827, filed on Sep. 24, 2007.

(51) Int. Cl. H04H 20/71

(52) U.S. Cl. 370/312

(57) ABSTRACT

An embodiment includes based on an evaluation of multicast communication session identifier(s) of a given multicast communication session, selecting between (i) querying a remote server for a multicast flow identifier, and (ii) applying a pre-defined mapping protocol to the multicast communication session identifier(s) to generate the multicast flow identifier. Another embodiment includes, based on an evaluation of a multicast flow identifier of a given multicast communication session selecting between (i) querying a remote server to obtain a set of session parameters for the given multicast communication session, and (ii) loading a set of pre-defined session parameters for the given multicast communication session. Another embodiment includes applying a pre-defined mapping protocol to (i) a given portion of a first multicast communication session identifier, (ii) a given portion of a second multicast identifier and (iii) a pre-defined prefix in order to generate a multicast flow identifier.

The present Application is a continuation-in-part of and claims priority to Non-Provisional application Ser. No. 12/235,450, entitled “GENERATING MULTICAST FLOW IDENTIFIERS”, filed Sep. 22, 2008, which claims priority to Provisional Application No. 60/974,827 by Song et al., entitled “Methods of generating multicast flow identifiers”, filed Sep. 24, 2007, each of which is assigned to the assignee hereof and each of which is hereby expressly incorporated by reference herein in its entirety.

### BACKGROUND OF THE INVENTION

1. Field of the Invention

Embodiments relate to communications in a wireless telecommunication system and, more particularly to selectively generating multicast flow identifiers and selectively obtaining session parameters for a multicast communication session within the wireless telecommunication system.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1xEV-DO standards, for example) or TD-SCDMA.

In wireless communication systems, mobile stations, handsets, or access terminals (AT) receive signals from fixed position base stations (also referred to as cell sites or cells) that support communication links or service within particular geographic regions adjacent to or surrounding the base stations. Base stations provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the base stations generally interact with ATs through an over the air interface and with the AN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as CDMA, FDMA, TDMA, GSM, etc. In a dispatch model, communication between endpoints (ATs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

Conventionally, data packets within a wireless communication network have been configured to be sent to a single destination or access terminal. A transmission of data to a single destination is referred to as “unicast”. As mobile communications have increased, the ability to transmit given data concurrently to multiple access terminals has become more important. Accordingly, protocols have been adopted to support concurrent data transmissions of the same packet or message to multiple destinations or target access terminals. A “broadcast” refers to a transmission of data packets to all destinations or access terminals (e.g., within a given cell, served by a given service provider, etc.), while a “multicast” refers to a transmission of data packets to a given group of destinations or access terminals. In an example, the given group of destinations or “multicast group” may include more than one and less than all of possible destinations or access terminals (e.g., within a given group, served by a given service provider, etc.). However, it is at least possible in certain situations that the multicast group comprises only one access terminal, similar to a unicast, or alternatively that the multicast group comprises all access terminals (e.g., within a given cell, etc.), similar to a broadcast.

Broadcasts and/or multicasts may be performed within wireless communication systems in a number of ways, such as performing a plurality of sequential unicast operations to accommodate the multicast group, allocating a unique broadcast/multicast channel (BCH) for handling multiple data transmissions at the same time and the like. A conventional system using a broadcast channel for push-to-talk communications is described in United States Patent Application Publication No. 2007/0049314 dated Mar. 1, 2007 and entitled “Push-To-Talk Group Call System Using CDMA 1x-EVDO Cellular Network”, the contents of which are incorporated herein by reference in its entirety. As described in Publication No. 2007/0049314, a broadcast channel can be used for push-to-talk calls using conventional signaling techniques. Although the use of a broadcast channel may improve bandwidth requirements over conventional unicast techniques, the conventional signaling of the broadcast channel can still result in additional overhead and/or delay and may degrade system performance.

The 3^{rd} Generation Partnership Project 2 (“3GPP2”) defines a broadcast-multicast service (BCMCS) specification for supporting multicast communications in CDMA2000 networks. Accordingly, a version of 3GPP2's BCMCS specification, entitled “CDMA2000 High Rate Broadcast-Multicast Packet Data Air Interface Specification”, dated Feb. 14, 2006, Version 1.0 C.S0054-A, is hereby incorporated by reference in its entirety.

### SUMMARY

An embodiment includes based on an evaluation of multicast communication session identifier(s) of a given multicast communication session, selecting between (i) querying a remote server for a multicast flow identifier, and (ii) applying a pre-defined mapping protocol to the multicast communication session identifier(s) to generate the multicast flow identifier. Another embodiment includes, based on an evaluation of a multicast flow identifier of a given multicast communication session selecting between (i) querying a remote server to obtain a set of session parameters for the given multicast communication session, and (ii) loading a set of pre-defined session parameters for the given multicast communication session. Another embodiment includes applying a pre-defined mapping protocol to (i) a given portion of a first multicast communication session identifier, (ii) a given portion of a second multicast identifier and (iii) a pre-defined prefix in order to generate a multicast flow identifier.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2 illustrates the carrier network according to an embodiment of the present invention.

FIG. 3 is an illustration of an access terminal in accordance with at least one embodiment of the invention.

FIG. 4 illustrates a conventional broadcast multicast service (BCMCS) flow discovery process.

FIG. 5 illustrates a multicast messaging process.

FIG. 6 illustrates a BCMCSFlowID acquisition process performed at an access terminal.

FIG. 7 illustrates a BCMCSFlowID generation process according to an embodiment of the present invention.

FIG. 8 illustrates a selective application of a static mapping-rule for BCMCSFlowID generation at a broadcast serving node (BSN) in accordance with an embodiment of the present invention.

FIG. 9 illustrates a selective application of a static mapping-protocol for BCMCSFlowID generation at an AT in accordance with an embodiment of the present invention.

FIG. 10 illustrates a process by which an access network selects between querying a BCMCS controller and using a look-up table maintained at an access network for obtaining session-parameters in accordance with an embodiment of the present invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as an access terminal (AT), may be mobile or stationary, and may communicate with one or more HDR base stations, referred to herein as modem pool transceivers (MPTs) or base stations (BS). An access terminal transmits and receives data packets through one or more modem pool transceivers to an HDR base station controller, referred to as a modem pool controller (MPC), base station controller (BSC) and/or packet control function (PCF). Modem pool transceivers and modem pool controllers are parts of a network called an access network. An access network transports data packets between multiple access terminals.

The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the modem pool transceiver is called a reverse link or traffic channel. The communication link through which a modem pool transceiver sends signals to an access terminal is called a forward link or traffic channel. As used herein the term traffic channel can refer to either a forward or reverse traffic channel.

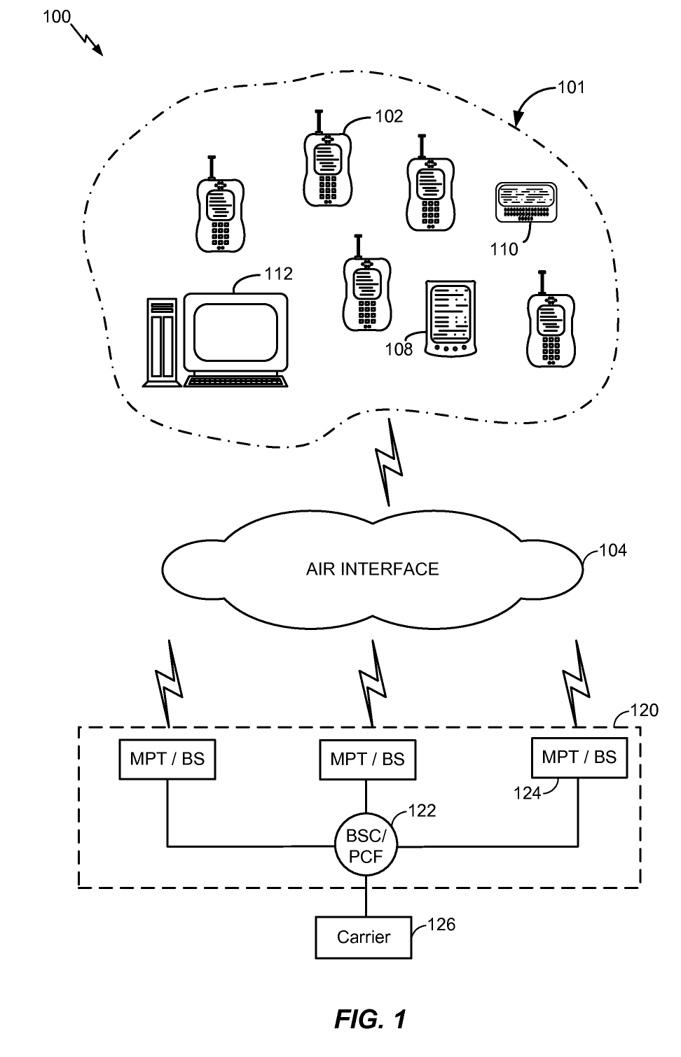

FIG. 1 illustrates a block diagram of one exemplary embodiment of a wireless system 100 in accordance with at least one embodiment of the invention. System 100 can contain access terminals, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or carrier network 126) and the access terminals 102, 108, 110, 112. As shown here, the access terminal can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the terms “access terminal”, “wireless device”, “client device”, “mobile terminal” and variations thereof may be used interchangeably.

Referring back to FIG. 1, the components of the wireless network 100 and interrelation of the elements of the exemplary embodiments of the invention are not limited to the configuration illustrated. System 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, the Internet, and/or other remote servers.

The RAN 120 controls messages (typically sent as data packets) sent to a base station controller/packet control function (BSC/PCF) 122. The BSC/PCF 122 is responsible for signaling, establishing, and tearing down bearer channels (i.e., data channels) between a packet data service node 100 (“PDSN”) and the access terminals 102/108/110/112. If link layer encryption is enabled, the BSC/PCF 122 also encrypts the content before forwarding it over the air interface 104. The function of the BSC/PCF 122 is well-known in the art and will not be discussed further for the sake of brevity. The carrier network 126 may communicate with the BSC/PCF 122 by a network, the Internet and/or a public switched telephone network (PSTN). Alternatively, the BSC/PCF 122 may connect directly to the Internet or external network. Typically, the network or Internet connection between the carrier network 126 and the BSC/PCF 122 transfers data, and the PSTN transfers voice information. The BSC/PCF 122 can be connected to multiple base stations (BS) or modem pool transceivers (MPT) 124. In a similar manner to the carrier network, the BSC/PCF 122 is typically connected to the MPT/BS 124 by a network, the Internet and/or PSTN for data transfer and/or voice information. The MPT/BS 124 can broadcast data messages wirelessly to the access terminals, such as cellular telephone 102. The MPT/BS 124, BSC/PCF 122 and other components may form the RAN 120, as is known in the art. However, alternate configurations may also be used and the invention is not limited to the configuration illustrated. For example, in another embodiment the functionality of the BSC/PCF 122 and one or more of the MPT/BS 124 may be collapsed into a single “hybrid” module having the functionality of both the BSC/PCF 122 and the MPT/BS 124.

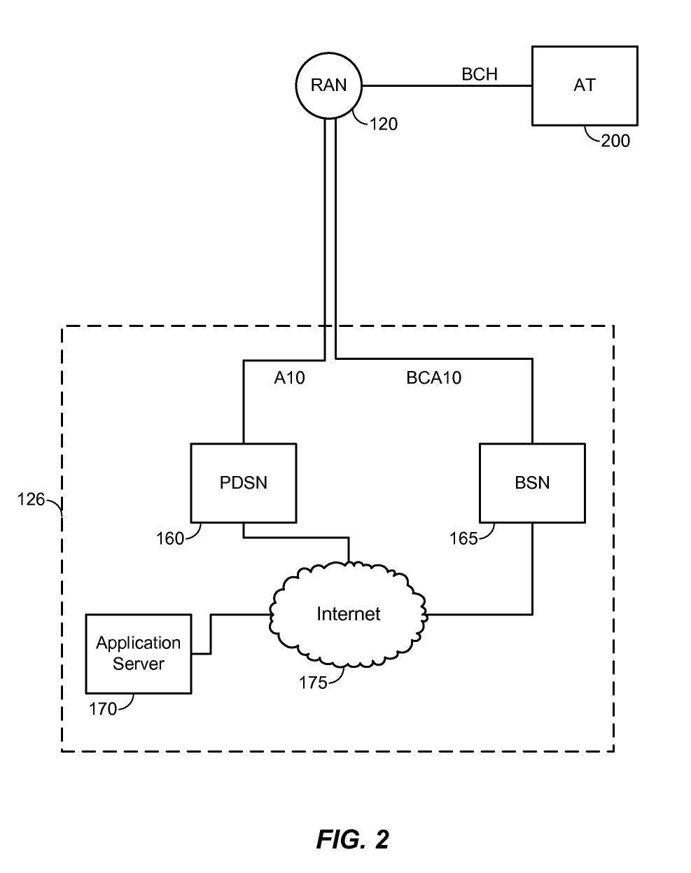

FIG. 2 illustrates the carrier network 126 according to an embodiment of the present invention. In the embodiment of FIG. 2, the carrier network 126 includes a packet data serving node (PDSN) 160, a broadcast serving node 165, an application server 170 an Internet 175 and a broadcast and multicast service (BCMCS) controller 180. However, application server 170 and other components may be located outside the carrier network in alternative embodiments. The PDSN 160 provides access to the Internet 175, intranets and/or remote servers (e.g., application server 170) for mobile stations (e.g., access terminals, such as 102, 108, 110, 112 from FIG. 1) utilizing, for example, a cdma2000 Radio Access Network (RAN) (e.g., RAN 120 of FIG. 1). Acting as an access gateway, the PDSN 160 may provide simple IP and mobile IP access, foreign agent support, and packet transport. The PDSN 160 can act as a client for Authentication, Authorization, and Accounting (AAA) servers and other supporting infrastructure and provides mobile stations with a gateway to the IP network as is known in the art. As shown in FIG. 2, the PDSN 160 may communicate with the RAN 120 (e.g., the BSC/PCF 122) via a conventional A10 connection. The A10 connection is well-known in the art and will not be described further for the sake of brevity. While not illustrated, the application server 170 may be configured to include a broadcast and multicast service (BCMCS) content provider, one or more AAA servers, a push-to-talk (PTT) server, a media duplicator, a group management database, a call logging device, etc., the function of each being well-known in the art.

Referring to FIG. 2, the broadcast serving node (BSN) 165 may be configured to support multicast and broadcast services. The BSN 165 will be described in greater detail below. The BSN 165 communicates with the RAN 120 (e.g., the BSC/PCF 122) via a broadcast (BC) A10 connection, and with the application server 170 via the Internet 175. The BCA10 connection is used to transfer multicast and/or broadcast messaging. Accordingly, the application server 170 sends unicast messaging to the PDSN 160 via the Internet 175, and sends multicast messaging to the BSN 165 via the Internet 175.

Again referring to FIG. 2, a BCMCS content server (not shown) makes BCMCS content (e.g., push-to-talk (PTT) audio packets) available within an IP multicast stream. If higher layer encryption is enabled, the BCMCS content server may encrypt the stream content. The BCMCS controller 180 is the core network element responsible for managing and providing BCMCS session information to the PDSN 160 and/or BSN 165, the access terminal(s), and the BCMCS content server (not shown). The BCMCS controller 180 also performs authorization using the BCMCS user profile received from a subscriber profile database (not shown) through one or more AAA servers. The BCMCS controller 180 serves the function of multicast services encryption key distribution, and can also perform discovery operations to find desired content, such as “BCMCS flow discovery”, which will be described later in greater detail.

Generally, as will be described in greater detail below, the RAN 120 transmits multicast messages, received from the BSN 165 via the BCA10 connection, over a broadcast channel (BCH) of the air interface 104 to one or more access terminals 200.

In BCMCS flow discovery, an access terminal is provided higher-level multicast group information (e.g., a multicast IP address and port associated with a given multicast group) via an application-layer message, but the access terminal still needs to determine which BCMCS flow ID, which identifies a multicast flow carried, or scheduled to be carried, by the RAN 120 (e.g., in either a current or future PTT session) on a broadcast channel (BCH), is associated with the desired multicast group. Accordingly, the access terminal sends a request to the BCMCS controller 180, which responds with the requested BCMCS flow ID, such that the access terminal may then register for and/or “tune” with the RAN 120.

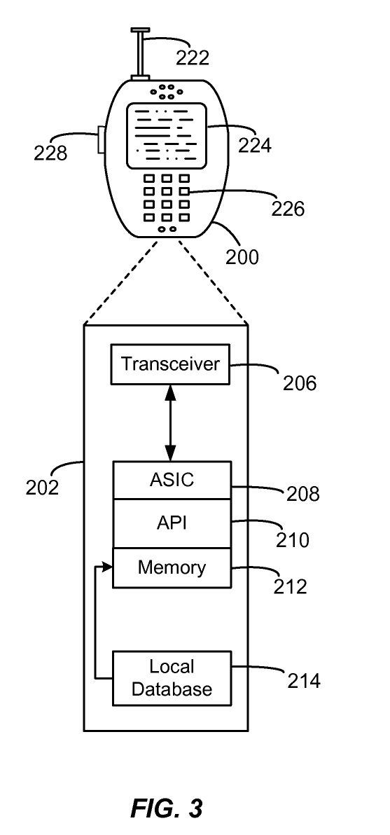

Referring to FIG. 3, an access terminal 200, (here a wireless device), such as a cellular telephone, has a platform 202 that can receive and execute software applications, data and/or commands transmitted from the RAN 120 that may ultimately come from the carrier network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API”) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include an access terminal including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 3 are to be considered merely illustrative and the invention is not limited to the illustrated features or arrangement.

The wireless communication between the access terminal 102 and the RAN 120 can be based on different technologies, such as code division multiple access (CDMA), WCDMA, time division multiple access (TDMA), frequency division multiple access (FDMA), Orthogonal Frequency Division Multiplexing (OFDM), the Global System for Mobile Communications (GSM), or other protocols that may be used in a wireless communications network or a data communications network. The data communication is typically between the client device 102, MPT/BS 124, and BSC/PCF 122. The BSC/PCF 122 can be connected to multiple data networks such as the carrier network 126, PSTN, the Internet, a virtual private network, and the like, thus allowing the access terminal 102 access to a broader communication network. As discussed in the foregoing and known in the art, voice transmission and/or data can be transmitted to the access terminals from the RAN using a variety of networks and configurations. Accordingly, the illustrations provided herein are not intended to limit the embodiments of the invention and are merely to aid in the description of aspects of embodiments of the invention.

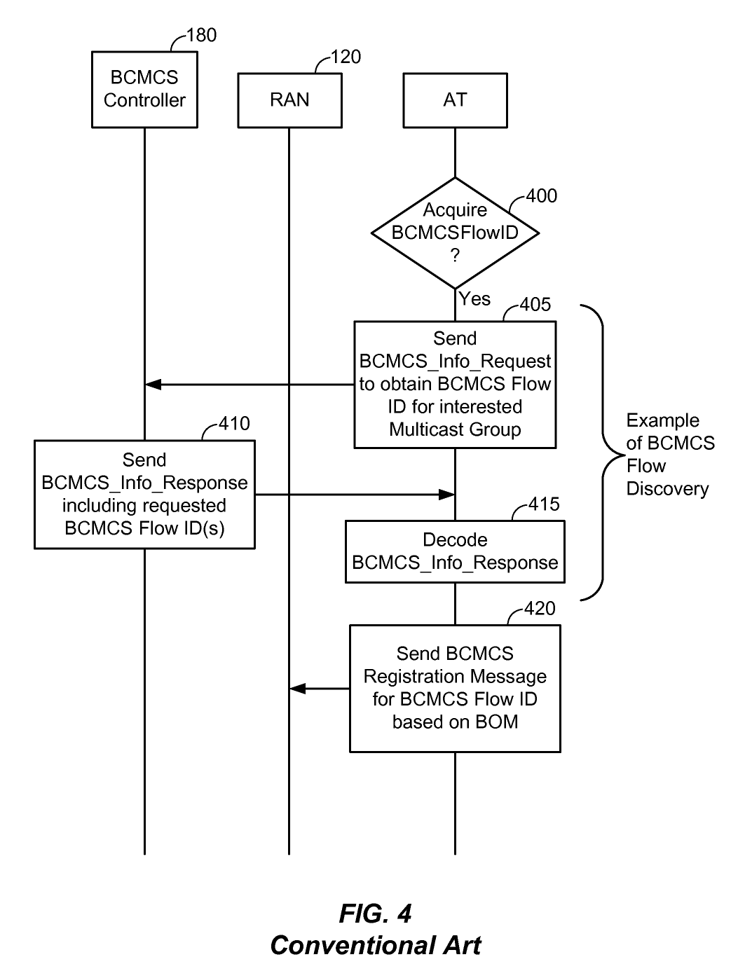

As discussed in the Background section, multicast messaging may be performed in a number of ways. In order to better understand embodiments of the present invention, a conventional BCMCS flow discovery process will be described with respect to FIG. 4, respectively. Then, a multicast messaging process according to an embodiment of the present invention will be described in greater detail.

FIG. 4 illustrates a conventional BCMCS flow discovery process. For example, while not shown in FIG. 4, a given AT can subscribe to a particular multicast or broadcast program, and can acquire program information that includes a multicast IP address and port designation number for the requested program. Once the AT acquires the multicast IP address and port designation number, the given AT can perform the process of FIG. 4 in order to obtain a broadcast multicast service (BCMCS) flow ID for the program. The BCMCSFlowID is conventionally a number or identifier, assigned by the BCMCS controller 180, that is used to distinguish between multicast flows either currently carried or scheduled to be carried (e.g., at a future point in time) by the RAN 120. Thus, because the given AT desires to monitor the multicast session carried by the RAN 120, the given AT must query the BCMCS controller 180 to learn the BCMCSFlowID for the associated program.

In 400, the given AT determines whether to acquire a BCMCSFlowID for the given multicast session or program (e.g., in order to register for the session or program). If the given AT determines to register for the given multicast session or program (e.g., responsive to a user's program request, etc.), in 405, the access terminal sends a BCMCS information request message (“BCMCS_Info_Request”) to the BCMCS controller 180. The BCMCS_Info_Request message contains the multicast IP address/port combinations for each multicast group (e.g., a static group). The BCMCS controller 180 retrieves information on the relative priority of the forward link streams. Also, the BCMCS controller 180 authenticates the user.

As discussed above, each BCMCS Flow ID is conventionally assigned or allocated by the BCMCS controller 180 and is used to distinguish between flows carried by the RAN 120. Each BCMCS Flow ID corresponds to a particular multicast IP address and port, such that each unique “pair” of multicast IP address and port designation number has its own BCMCS Flow ID. In an example, the BCMCS flow ID may be 16, 24, or 32 bits in length, and can include certain sub-fields that convey information. Alternatively, in another example, the BCMCSFlowID can simply be an arbitrary number used to distinguish between different multicast flows, and need not include sub-fields that convey information.

In 410, the BCMCS controller 180 sends a BCMCS information response message (“BCMCS_Info_Response”) to the access terminal, which contains the BCMCS session information such as mobile security parameters and BCMCS flow identifier(s) for each multicast group identified by the BCMCS_Info_Request. The access terminal decodes the BCMCS_Info_Response message received from the BCMCS controller 180 in 415, and extracts one or more BCMCSFlowIDs associated with the multicast group.

Next, in 420, the given AT sends a BCMCSFlowRegistration message, including the BCMCS Flow ID (e.g., acquired in 410, 415) in order to register for the multicast program or flow with the RAN 120. For example, the BCMCSFlowRegistration message sent in 420 may be responsive to a broadcast overhead message (BOM) having a register for dynamic broadcast (RFDB) bit set to a first logic level (e.g., a higher logic level or logic “1”). BOMs are well-known in the art, and include a listing or advertisement of BCMCSFlowIDs being carried by the RAN 120 in a particular sector or a particular carrier within a sector. The RFDB bit can be used to trigger transmissions of BCMCSFlowRegistration messages from ATs interested in one of the advertised BCMCS flows.

Accordingly, after the given AT performs the BCMCS flow discovery process of FIG. 4, the given AT knows the BCMCSFlowID used by the RAN 120 to identify the given AT's desired program or multicast session. The given AT can then identify its desired program based on the program's BCMCSFlowID when the program is advertised in a BOM, and can register for the desired program.

As will be appreciated from a review of the above-described process of FIG. 4, ATs interested in participating in multicast sessions or programs are required to query the BCMCS controller 180 in order to obtain the BCMCSFlowID for the desired program. Thus, the BCMCS flow discovery process of FIG. 4 includes messaging between the BCMCS controller 180 and one or more ATs to allocate the requested BCMCSFlowID.

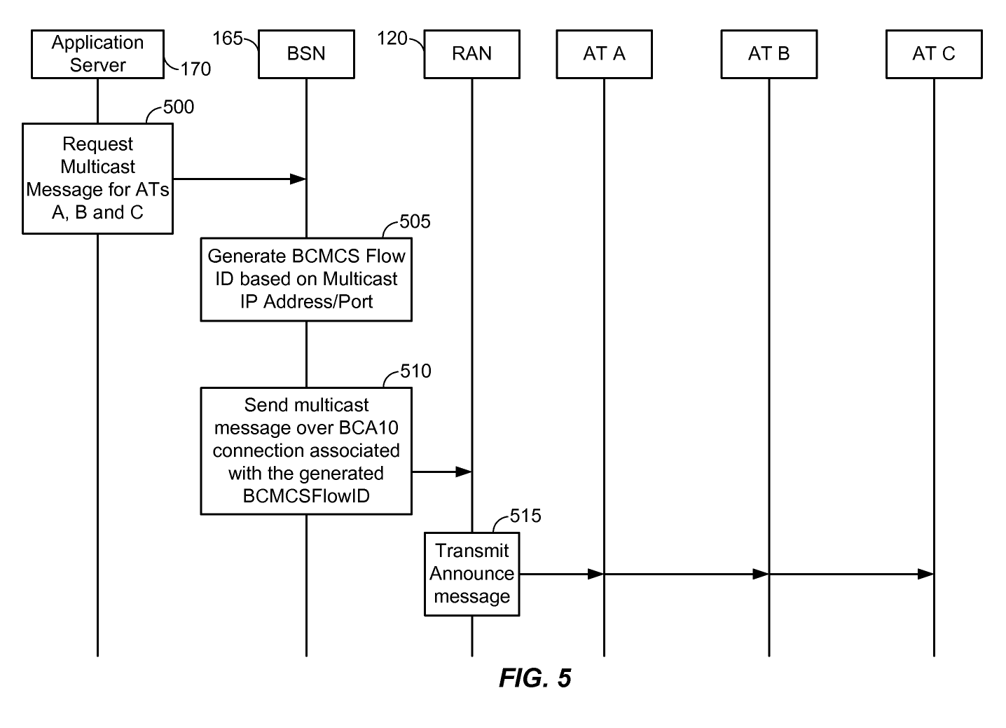

In the embodiment of FIG. 5, in 500, the application server 170 requests a multicast message, for example an announce message for initiating a multicast session, be sent to a multicast group including ATs A, B and C. The multicast message from 500 is routed to the BSN 165.

In 505, upon receiving the multicast message, the BSN 165 generates a BCMCS flow ID based on a pre-configured multicast IP address and port designation number associated with the PTT session to be announced. Hereinafter, assume that ATs A through C, the RAN 120, the BSN 165 and the BCMCS controller 180 are each provisioned with the multicast IP address and port designation number of the program associated with the multicast message.

Each PTT session is associated with (i) a multicast IP address and (ii) a port designation number. The multicast IP address and port designation number function together as a unique identifier for a particular multicast group and/or session. For example, according to RFC 2365 standards for Administratively Scoped IP Multicast, the 239.192.0.0/14 address range is allocated for IPv4 organization-local scope. Thus, if the multicast message is configured to comply with the IPv4 organization-local scope address range, 18 bits (e.g., 32 minus 14, with 14 corresponding to a number of bits in a masked portion of the 32 bit multicast IP address) may be sufficient to designate the multicast IP address.

Further, the Internet Assigned Number Authority (IANA) divides port designation numbers into three ranges: (i) well-known ports [0-1023], (ii) registered ports [1024-49151] and (iii) dynamic and/or private ports [49152-65535]. In binary, the port designation numbers for (iii) may typically have a 16-bit format of [11XXXXXXXXXXXXXX], because the decimal numbers at the low end, 49152, and the high end, 65535, of the dynamic and/or private port range may each be represented with 16 binary bits with the two most significant bits (MSBs) being 1, wherein the X's represent variable binary values that change based on the decimal port designation number. However, it will be appreciated that other port designation number formats and/or ranges may be manually configured, and need not be limited to the specifications provided above.

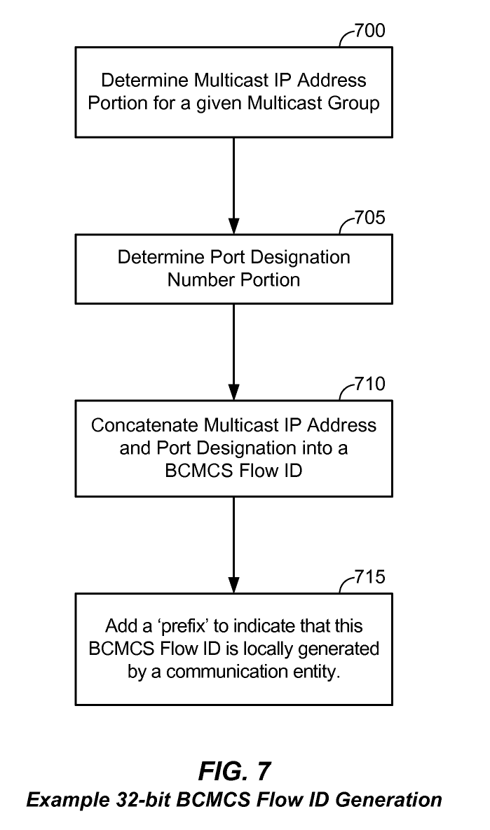

As discussed above with respect to FIG. 4, BCMCSFlowIDs are conventionally assigned throughout the wireless communication system 100 by a centralized communication entity (i.e., the BCMCS controller 180). However, as will be described in greater detail below with respect to FIG. 7, an embodiment of the present invention is directed to communication entities (e.g., the BSN 165, ATs A, B and/or C, etc.) generating BCMCS flow IDs based on multicast IP address and port designation number information provisioned thereon, such that BCMCS Flow Discovery need not be performed.

In 510, the BSN 165 forwards the multicast message along with the generated BCMCSFlowID (e.g., in a packet header of the multicast message, in a separate multicast packet, etc.) over the BCA10 connection to the RAN 120. For example, the BSN 165 may forward the multicast message to the BSC/PCF 122, which may analyze the multicast group members associated with the multicast message and forwards the multicast message to each MPT/BS 124 serving one or more multicast group members.

After receiving the forwarded multicast message from the BSN 165, the RAN 120 transmits an announce message announcing the PTT session in 515. In an example, the announce message is transmitted within a data over signaling (DOS) message on a downlink control channel. In another example, the announce message is transmitted on a downlink broadcast channel (BCH) subsequent to sending a broadcast overhead message (BOM) informing ATs with regard to how to “tune” to the announce message on the BCH. Each of the above-described announce message transmission protocols is described in greater detail within co-pending U.S. Patent Application No. 60/974,833, entitled “MULTICAST MESSAGING WITHIN A WIRELESS COMMUNICATION SYSTEM”, filed on Sep. 24, 2007, assigned to the assignee hereof, and expressly incorporated by reference herein in its entirety.

As will be appreciated from the foregoing description of the exemplary multicast messaging process of FIG. 5, the BCMCS flow ID may be dynamically generated at the BSN 165 based on the multicast IP address and port designation number, which will be described in greater detail below with respect to FIG. 7. Accordingly, the BCMCS controller 180 need not be consulted when determining the BCMCSFlowID, and the BCMCSFlowID may be generated at separate communication entities (e.g., at one or more ATs, at the BSN 165, etc.) so long as each communication entity knows (i) the multicast IP address, (ii) the port designation number, and (iii) the rule or methodology of “packaging” (i) and (ii). Thereby, wasteful traffic (e.g., BCMCSFlowDiscovery) can be reduced or avoided because disparate communication entities can independently calculate the same BCMCSFlowID for a particular multicast group or PTT session.

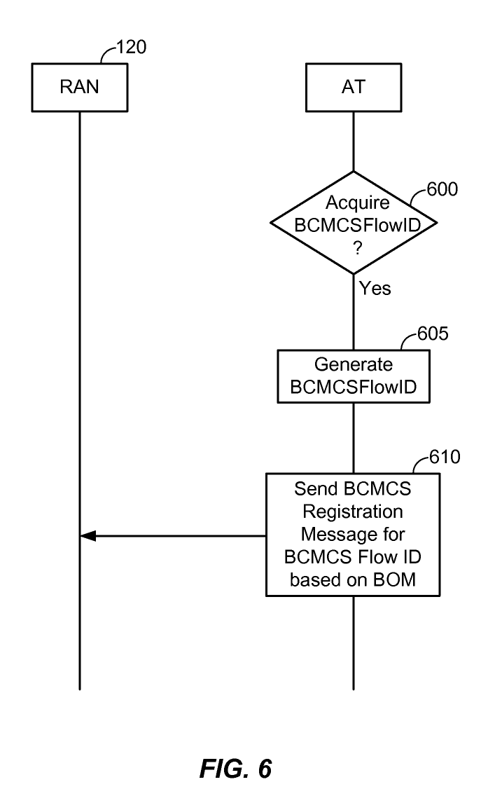

FIG. 6 illustrates a BCMCSFlowID acquisition process performed at an access terminal according to an embodiment of the present invention. In 600, a given AT determines whether to acquire a BCMCSFlowID for a particular PTT session or multicast session (e.g., in order to send a BCMCSFlowRegistration message to register for a multicast or PTT session). If the given AT determines to acquire the BCMCSFlowID, the given AT generates a BCMCSFlowID for the PTT session, 605, based on the multicast IP address and port designation number for the particular PTT session. For example, the BCMCSFlowID may be generated in accordance with the process of FIG. 7, which is discussed below in greater detail. After generating the BCMCSFlowID in 605, the given AT can send a BCMCSFlowRegistration message to the RAN 120, 610, in order to register for the PTT session. For example, the given AT may determine to send the BCMCSFlowRegistration message in response to a BOM having an register for dynamic broadcast (RFDB) field set to 1, in response to an announce message, and the like.

As will be appreciated by one of ordinary skill in the art, because the given AT can generate the BCMCSFlowID independently, based on the multicast IP address and port designation number provisioned at the given AT, without querying the BCMCS controller 180, the delays and traffic associated with the conventional BCMCS flow discovery process of FIG. 4 can be reduced and/or avoided.

As discussed above with respect to FIGS. 5 and 6, the BSN 165 and/or any of ATs A, B and/or C can generate a BCMCSFlowID for a particular multicast session. Accordingly, an example of BCMCS flow ID generation based on the (i) multicast IP address and the (ii) port designation number will now be described in more detail below with respect to FIG. 7. Because the process of FIG. 7 can be executed at any of a number of communication entities (e.g., the BSN 165, one or more ATs, etc.), the process is below described as being generically implemented at a “communication entity”.

In 700, assume the multicast IP address is configured to include 32 bits (e.g., in accordance with the IPv4 organization-local scope address range). Within the 32 bit multicast IP address, a given portion (e.g., 18 bits) may be sufficient to designate the multicast IP address. For example, if it is known that no more than 2¹⁸ multicast groups are used during operation of the wireless communication system 100, then 18 bits may be sufficient to distinguish between the 2¹⁸ multicast groups. Thus, a given sequence of 14 bits within the 32 bit multicast IP address can be reserved or “masked” (e.g., for multicast sessions, for BCMCS sessions, etc.), and each of the BSN 165, the RAN 120, the BCMCS controller 180 and the ATs participating in the PTT session are pre-configured with knowledge of the 14 “masked” bits (e.g., in order to mask the correct bits during BCMCSFlowID generation). In other words, the 14 “masked” bits can be added to the 18 bit-portion to re-construct the 32-bits of the whole multicast IP address. Thus, in 700, the communication entity determines the 18-bit non-masked bits of the multicast IP address for a given PTT session, referred to as the “18-bit Multicast IP Address Portion”.

Next, in 705, the BSN 165 determines the 16 bit port designation number for the given PTT session. As discussed above, the port designation number is a binary representation of a decimal number in the range from 0 to 65535, based on which type of port is designated (e.g., a well-known port, a registered port, or a dynamic and/or private port). In an embodiment of the invention, PTT or multicast applications will be assumed to use a port designation number between 49152 and 65535. Because any port designation number of a dynamic and/or private port begins with a binary “11” for reasons discussed above, it will be appreciated that only 14 bits need be used to designate a dynamic and/or private port. Accordingly, in 705, the two “unnecessary” bits within the 16 bit port designation number are removed, resulting in the 14 sufficient bits for distinguishing between dynamic and/or private ports.

Furthermore, only a subset of the dynamic and/or private ports can be used to coexist with other applications that use the same multicast IP address range yet use different ports. For example, only dynamic and/or private ports that begin with a binary “111111” can be used. In this case, fewer than 14 bits of the port designation number can be used for representing the ports to be used according to this embodiment. For example, assuming that six (6) bits of the 16-bit port designation number can be masked, 10 bits are sufficient for representing the ports to be used according to this embodiment, referred to as the “10-bit Port Designation Number Portion”). As will be appreciated, the number of bits from the 16-bit port designation number that are masked and the number of bits from the 16-bit port designation number that are not masked and used in the port designation number portion can scale up or down based on the number of unique ports required for a particular application. Accordingly, while examples are provided below whereby the port designation number portion equals 10 bits, but it will be appreciated that the length of the port designation number portion can be different in other embodiments of the invention.

Next, the 10-bit Port Designation Number Portion and the 18-bit Multicast IP Address Portion are combined or “concatenated” in order to generate a 28 bit non-prefix portion of the BCMCSFlowID in 710, which leaves four (4) ‘free’ or unused bits. The 4 free bits, the port designation number portion and the multicast IP address portion may be concatenated in any order (e.g., [4 free bits, port designation number portion, multicast IP address portion], [multicast IP address portion, 4 free bits, port designation number portion], etc.), so long as the order is used consistently so as not to “confuse” other network elements, such as the RAN 120 and/or the target ATs, which may each be configured to apply the same BCMCSFlowID generation or ‘packaging’ rule or protocol.

Finally, a pre-defined ‘prefix’ (e.g., 0001, 1101, etc.) is added to construct a 32 bit BCMCSFlowID in 715. The pre-defined prefix can be extracted from a portion of the multicast IP address and/or port designation number, in an example, such as from the masked portion(s) of the multicast IP address and/or port designation number. Alternatively, the prefix can be generated independently of the multicast IP address and/or port designation number. The pre-defined prefix that is added to the BCMCSFlowID is expected to be recognized by the RAN 120, such that the RAN 120 will infer the manner in which the BCMCSFlowID was generated (e.g., which bits belong to the Multicast IP Address Portion, which bits are prefix-bits, which bits are Port Designation Number Portion, etc.) based on the recognition or detection of the pre-defined prefix within the BCMCSFlowID.

For example, the prefix can be added to the portion of the BCMCSFlowID that contains unused or free bits. Thus, in the example given above, prefixes with a size of up-to four (4) bits can be inserted into the BCMCSFlowID in 715. As noted above, the particular prefix that is inserted into the BCMCSFlowID can be configured to be used or recognized by other communication entities (e.g., RAN 120) to prompt certain actions. For example, a pre-defined prefix can be inserted and later recognized when the BCMCSFlowID arrives at the RAN 120, whereby the prefix of the BCMCSFlowID indicates that the BCMCSFlowID has been locally generated by other communication entities (e.g., BSN and/or AT), and not retrieved from the BCMCS controller 180, in an example. While the example above shows a 4-bit prefix inserted into a 4-bit unused portion of the BCMCSFlowID, it will be appreciated that a smaller prefix could be inserted into the unused portion in another embodiment. In this case, any remaining unused bit could simply be garbage bits or set to some predetermined setting, such as all 1's or all 0's.

Examples of BCMCSFlowID generation will now be described with respect to FIG. 7. In a first example, assume the format of the 32 bit multicast IP address, with its associated 14-bit masked portion and 18-bit Multicast IP Address Portion, is as follows:

32-bit Multicast IP Address

| 14-bit “Masked” Portion | | | | | | | | | | | | | | 18-bit Multicast IP Address Portion | | | | | | | | | | | | | | | | |
|---|---|---|---|---|---|---|---|---|---|---|---|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 | 12 | 11 | 10 | 9 | 8 7 | 6 | 5 | 4 | 3 | 2 | 1 | 0 |
| X | X | X | X | X | X | X | X | X | X | X | X | X | X | 1 | 1 | 1 | 1 | 1 | 1 | 1 | 1 | 1 | 1 0 | 0 | 0 | 0 | 0 | 0 | 0 | 0 |

While the 32-bit multicast IP address is shown above as having a 14-bit Masked portion and an 18-bit Multicast IP address portion as separate blocks of contiguous bits, it will be appreciated that, in other embodiments of the invention, the bit mapping of the masked portion and multicast IP address portion need not be configured as above. For example, the Multicast IP address portion may correspond to the MSBs, and the masked portion may correspond to the LSBs. In another alternative example, the masked and multicast IP address portions may alternate, or may be interleaved throughout the 32-bit string (e.g., as non-contiguous bits). So long as the network entities that generate BCMCSFlowID are aware of how the bits of the 32-bit multicast IP address (e.g., or a multicast IP address of a different length) are arranged, the relevant information (i.e., the multicast IP address portion) may be extracted at the different network entities for BCMCSFlowID generation.

Further, it will be appreciated that the multicast IP address portion indicated above can correspond to a source IP address, a destination IP address, or a combination of a course and destination IP address. In the case of IPv4, the source IP address is unicast, and the destination IP address is multicast. In the example above, where the multicast IP address portion includes 18-bits, assuming IPv4, the 18-bits can thereby correspond to the source, destination or source/destination combination IP address. If the 18-bits mentioned above correspond to the source/destination combination IP address, then a given number of bits may be extracted from the source IP address, and a given number of bits may be extracted from the destination IP address, and the extracted bits may be combined in accordance with any mapping protocol (e.g., and not necessarily concatenated in contiguous-bit fashion, as will be appreciated, the bits can be interleaved or otherwise staggered, etc.). Accordingly, so long as disparate network entities agree in advance with regard to which bits are to be used during BCMCSFlowID generation, and the bits used are sufficient to uniquely identify the multicast program, then nearly any extraction/mapping protocol can be used to generate the multicast IP address portion discussed above.

Next, further assume that the 16 bit port designation number, with its 6-bit masked portion (e.g., which may be “11XXXX” as discussed above, but is denoted as “XXXXXX” below) and 10-bit Port Designation Number Portion, is as follows:

16-bit Port Designation Number

| 6-bit Mask | | | | | | 10-bit Port Designation Number Portion | | | | | | | | | |
|---|---|---|---|---|---|---|---|---|---|---|---|---|---|---|---|
| 15 | 14 | 13 | 12 | 11 | 10 | 9 | 8 | 7 | 6 | 5 | 4 | 3 | 2 | 1 | 0 |
| X | X | X | X | X | X | 0 | 0 | 0 | 0 | 1 | 1 | 1 | 1 | 1 | 1 |

While the 16-bit port designation number is shown above as having the 10-bit port designation number portion and 6-bit mask portion as separate blocks of contiguous bits, it will be appreciated that, in other embodiments of the invention, the bit mapping of the masked portion and multicast IP address portion need not be configured as above. For example, the port designation number portion may correspond to the MSBs, and the mask portion may correspond to the LSBs. In another alternative example, the masked and port designation number portions may alternate, or may be interleaved throughout the 16-bit string (e.g., as non-contiguous bits). So long as the network entities that generate BCMCSFlowIDs are aware of how the bits of the 16-bit port designation number (e.g., or a port designation number of a different length) are arranged, the relevant information (i.e., the port designation number portion) may be extracted at the different network entities for BCMCSFlowID generation.

With the above assumptions, in a first example, the 10-bit port designation number portion and 18-bit multicast IP address portion may be concatenated, to form the 32-bit BCMCSFlowID, wherein the 18-bit Multicast IP Address Portion corresponds to the 18 MSBs and the 10-bit Port Designation Number Portion corresponds to the 10 MSBs following the 18 MSBs of the Multicast IP Address Portion, leaving the four (4) LSBs as ‘free’ or unused bits. At this point, in 715 of FIG. 7, the free or unused bits are filled with a given prefix (i.e., “1000” in this example), as follows:

Example 32-bit BCMCSFlowID 1

| 18-bit Multicast IP Address Portion | | | | | | | | | | | | | | | | | | 10-bit Port Designation Number Portion | | | | | | | | | Prefix | | | |
|---|---|---|---|---|---|---|---|---|---|---|---|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 | 12 | 11 | 10 9 | 8 | 7 | 6 | 5 | 4 | 3 | 2 | 1 | 0 |
| 1 | 1 | 1 | 1 | 1 | 1 | 1 | 1 | 1 | 1 | 0 | 0 | 0 | 0 | 0 | 0 | 0 | 0 | 1 | 1 | 1 | 1 0 | 0 | 0 | 0 | 1 | 1 | 1 | 0 | 0 | 0 |

However, it will be appreciated that the 4-bit Prefix, the 10-bit Port Designation Number Portion and 18-bit Multicast IP Address Portion need not be concatenated as three distinct sets of contiguous bits. Rather, this has been shown above in Example 32-bit BCMCSFlowID 1 (e.g., and also in the alternative examples provided below) for the sake of convenience. In an alternative example, it will be appreciated that bits from the different portions can alternate, or be interleaved, such that a given block of contiguous bits need not include consecutive bits from the same portion exclusively. Thus, in this example, so long as the network entities using the BCMCSFlowID are aware of the manner that the bits of the 4-bit Prefix, the 10-bit Port Designation Number Portion and the 18-bit Multicast IP Address Portion are mapped to the BCMCSFlowID, the different network entities can independently generate and/or interpret the same BCMCSFlowID consistently without use of the BCMCS Flow Discovery process.

Alternatively, in a second example, the 10-bit Port Designation Number Portion and 18-bit Multicast IP Address Portion may be concatenated, to form the BCMCSFlowID, wherein the 18-bit Multicast IP Address Portion corresponds to the 18 LSBs and the Port Designation Number Portion corresponds to the 10 MSBs, leaving bit #s 21 . . . 18 as ‘free’ or unused bits. At this point, in 715 of FIG. 7, the free or unused bits are filled with a given prefix (i.e., “1000” in this example), as follows:

Example 32-bit BCMCSFlowID 2

| 10-bit Port Designation Number Portion | | | | | | | | | | Prefix | | | | 18-bit Multicast IP Address Portion | | | | | | | | | | | | | | | | |
|---|---|---|---|---|---|---|---|---|---|---|---|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 | 12 | 11 | 10 9 | 8 | 7 | 6 | 5 | 4 | 3 | 2 | 1 | 0 |
| 1 | 1 | 1 | 1 | 0 | 0 | 0 | 0 | 1 | 1 | 1 | 0 | 0 | 0 | 1 | 1 | 1 | 1 | 1 | 1 | 1 | 1 1 | 1 | 0 | 0 | 0 | 0 | 0 | 0 | 0 | 0 |

Another example of BCMCSFlowID generation based on another set of assumptions will now be described with respect to FIG. 7. In this example, assume the 32-bit multicast IP address, with its associated 14-bit masked portion and 18-bit Multicast IP Address Portion, is the same as in the BCMCSFlowID generation examples provided above. However, in this next example, assume that only 32 ports are required in, for example, BCMCS applications. It will be appreciated that only five (5) binary bits need be used to distinguish between 32 ports (e.g., because 2⁵=32). Thus, in this example, only five (5) bits need be reserved for the Port Designation Number Portion within the 32-bit BCMCSFlowID. Thus, the port designation number may be denoted as follows:

16-bit Port Designation Number

| | | | | | | | | | | | 5-bit Port | | | | |
|---|---|---|---|---|---|---|---|---|---|---|---|---|---|---|---|
| 2-bit | | | | | | | | | | | Designation | | | | |
| mask | | 9-bit Mask | | | | | | | | | Number Portion | | | | |
| 15 | 14 | 13 | 12 | 11 | 10 | 9 | 8 | 7 | 6 | 5 | 4 | 3 | 2 | 1 | 0 |
| X | X | X | X | X | X | X | X | X | X | X | 1 | 1 | 1 | 1 | 1 |

With the above assumptions, in an example, the 5-bit Port Designation Number Portion and 18-bit Multicast IP Address Portion may be concatenated, to form the BCMCSFlowID, wherein the 18-bit Multicast IP Address Portion corresponds to the 18 LSBs and the 5-bit Port Designation Number Portion corresponds to the 5 MSBs among the 23 LSBs, leaving nine (9) free or unused bits. At this point, in 715 of FIG. 7, the free or unused bits are filled with a given prefix (i.e., “111111000” in this example), as follows:

Example 32-bit BCMCSFlowID 3

| | | | | | | | | | 5-bit Port | | | | | | | | | | | | | | | | | | | | | |
|---|---|---|---|---|---|---|---|---|---|---|---|---|---|---|---|---|---|---|---|---|---|---|---|---|---|---|---|---|---|---|
| | | | | | | | | | Designation | | | | | | | | | | | | | | | | | | | | | |
| 9-bit Prefix | | | | | | | | | Number Portion | | | | | 18-bit Multicast IP Address Portion | | | | | | | | | | | | | | | | |
| 13 | 12 | 11 | 10 | 9 | 8 | 7 | 6 | 5 | 4 | 3 | 2 | 1 | 0 | 17 | 16 | 15 | 14 | 13 | 12 | 11 | 10 9 | 8 | 7 | 6 | 5 | 4 | 3 | 2 | 1 | 0 |
| 1 | 1 | 1 | 1 | 1 | 1 | 0 | 0 | 0 | 1 | 1 | 1 | 1 | 1 | 1 | 1 | 1 | 1 | 1 | 1 | 1 | 1 1 | 1 | 0 | 0 | 0 | 0 | 0 | 0 | 0 | 0 |

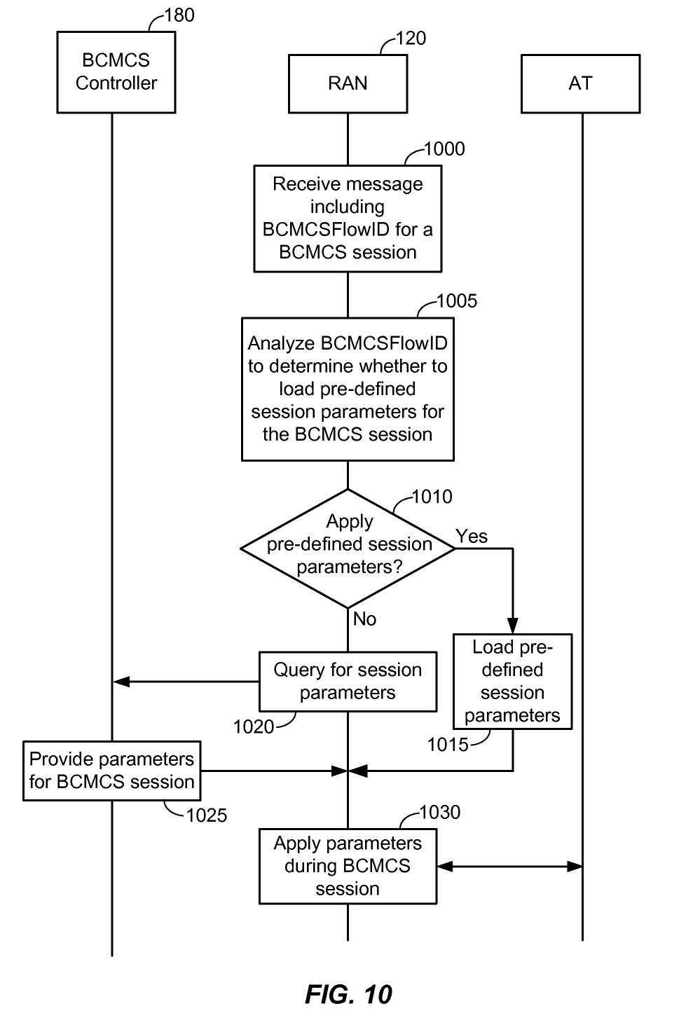

Further, as shown, the example 32-bit BCMCSFlowID 3 includes a 9-bit prefix because only 5-bits are required for the Port Designation Number Portion in this example, and as such 9 “extra” bits remain within the 32-bit BCMCSFlowID. In an example, the “extra” bits, or the 9-bit Prefix, can be used as a prefix to trigger certain operations at the RAN 120, as discussed above with respect to 715 of FIG. 7 and which will be discussed in more detail below with respect to FIG. 10. While not illustrated explicitly, it is appreciated that the different portions (i.e., 18-bit Multicast IP Address Portion, 5-bit Port Designation Number Portion, and 9-bit Prefix) can be concatenated in any order, and need not be limited to the example provided above. Thus, the 9-bit prefix example shows that the prefix need not be four (4) bits in each embodiment of the invention, but rather can scale based on the number of bits used in the port designation number portion. As noted above, less than all of the 9 free or unused bits may correspond to the actual prefix. For example, the same 4-bit prefix can be inserted into the unused portion so long as other communication entities know how the prefix is to be filled into the larger unused portion. In this case, a rule can be implemented for any remaining bits (e.g., all 1's, all 0's, etc.) such that a complete 32-bit BCMCSFlowID can still be generated.

In view of the above-description of FIG. 7, as will be appreciated by one of ordinary skill in the art, the BCMCS controller 180 is configured to refrain from assigning any BCMCSFlowIDs with “masked” bits equal to the masking of the multicast IP address and/or the port designation number so as not to conflict with BCMCSFlowIDs generated in accordance with the process of FIG. 7. Further, if an AT that is not configured to execute the process of FIG. 7 performs BCMCSFlowDiscovery to acquire the BCMCSFlowID, the BCMCS controller 180 may provision the BCMCSFlowID to the requesting AT based either on a local mapping table at the BCMCS controller 180 and/or by executing the process of FIG. 7 described above.

As will be appreciated by one of ordinary skill in the art, the BCMCSFlowID generation processes described above are dependent, in part, upon a pre-configuration or provisioning of a number of multicast IP addresses and port designation numbers at a number of network entities, such as the BSN 165, the RAN 120, one or more ATs, and the BCMCS controller 180 (e.g., in the sense that the BCMCS controller 180 is configured to at least not conflict with the BCMCSFlowID generation described in above-embodiments of the present invention).

Further, it will be appreciated by one of ordinary skill in the art that the mapping of a multicast IP flow to a BCMCS flow is applicable in the context of the BCMCS framework defined in CDMA systems. A multicast IP flow (defined by the multicast IP address and port designation number(s) can also be mapped using a similar approach directly to, for example, a 32-bit Multicast Access Terminal Identifier that is defined as part of the 1xEV-DO CDMA network for identifying handsets at the MAC layer (MAC layer ID). The MATI can then be used for multicasting at the MAC layer over the Forward Link in the EV-DO network. Either the Control Channel or a “shared forward traffic channel” may be used to transmit the MATI addressed packet over the air interface 104.

Mapping rules can be defined to allow more than one multicast IP flow to map to a specific BCMCSFlowID. This can be used, for example, where BCMCS Flow IDs are 8 or 16 bits, and are more limited in availability as compared to 32-bit BCMCSFlowIDs. In such cases, further differentiation can be achieved amongst multicast IP flows by mapping portions of the multicast IP address and port numbers to DSCP values within the IP header.

This approach can be further generalized to mapping a multicast IP flow to a multicast flow identifier in other systems such as WiMAX, DOCSIS and Ethernet. For example, in DOCSIS, a multicast IP flow can be mapped to a multicast MAC flow which is the Multicast Ethernet address of the modems that are assigned this address.

Further, while above-described embodiments of the present invention are directed to a single port for a multicast IP flow, other embodiments of the present invention can be directed to embodiments where a combination of source and destination ports are used (e.g., so long as disparate network entities agree in advance with regard to which bits are to be used during BCMCSFlowID generation, and the bits used are sufficient to uniquely identify the multicast program, then nearly any extraction/mapping protocol can be used to generate the port designation number portion discussed above). Also, while above-described embodiments of the present invention are generally directed to the generation of a 32-bit BCMCSFlowID, it will be appreciated that other embodiments of the present invention can be directed to BCMCSFlowIDs of different lengths (e.g., a 16 bit BCMCSFlowID, a 24-bit BCMCSFlowID, etc.).

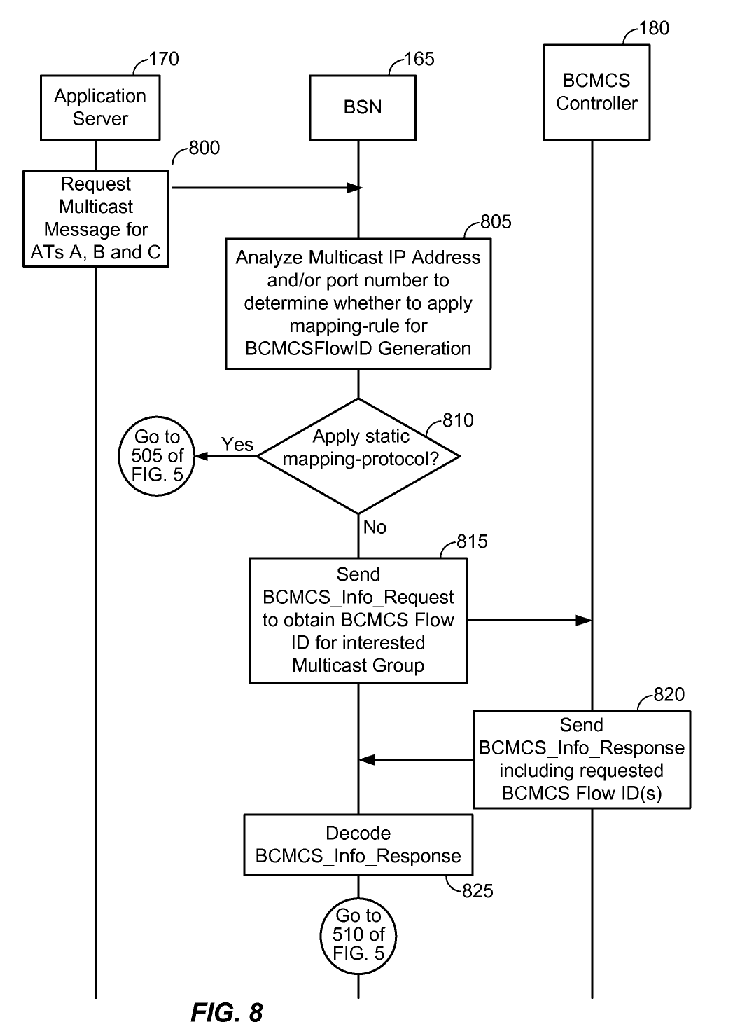

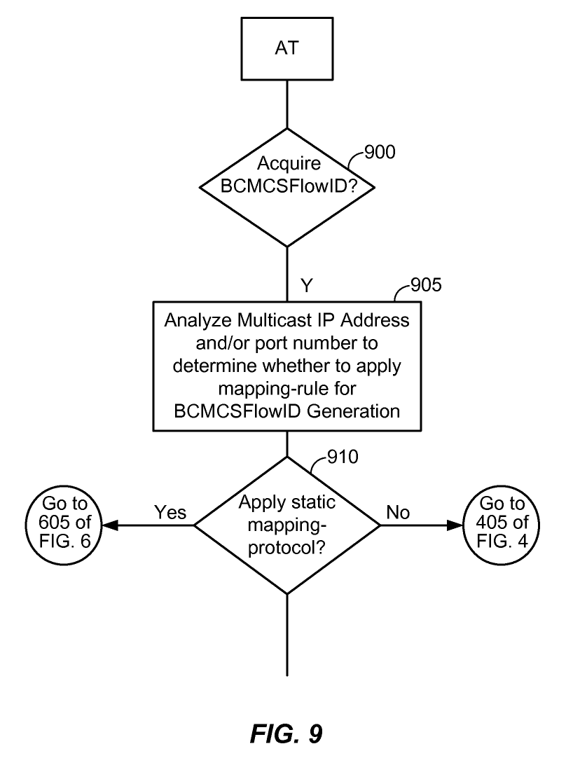

The embodiments describe above assume that the BSN 165 and/or ATs each automatically generate BCMCSFlowIDs based on the associated multicast IP address and port number of a respective multicast group during set-up of a multicast communication session. For example, FIG. 5 illustrates the BSN 165 generating the BCMCSFlowID by applying a mapping-rule that extracts bits of the multicast IP address and port number and merges these extracted bits in part to form the 32-bit BCMCSFlowID for the multicast session, and FIG. 6 illustrates a similar process performed at an AT. In alternative embodiments, described below with respect to FIGS. 8 and 9, the BSN 165 and AT(s) can first evaluate the multicast IP address and port number in order to determine whether the mapping-rule should be applied for BCMCSFlowID generation. This way, if the BSN 165 or AT(s) determine the mapping-rule should not be applied, the BCMCS controller 180 can simply be queried for the BCMCSFlowID.

Accordingly, FIG. 8 illustrates a selective application of a ‘static’ mapping-rule for BCMCSFlowID generation at the BSN 165 in accordance with an embodiment of the present invention. In the embodiment of FIG. 8, in 800, the application server 170 requests a multicast message, for example an announce message for initiating a multicast session, be sent to a multicast group. The multicast message from 800 is routed to the BSN 165.

In 805, upon receiving the multicast message, the BSN 165 evaluates a pre-configured multicast IP address and port designation number associated with the multicast or PTT session to be announced in order to determine whether to apply the static mapping-rule for BCMCSFlowID generation or alternatively whether to query the BCMCS controller 180 for the BCMCSFlowID. For example, the analysis of 805 can include comparing a given multicast IP address and/or port number with a pre-defined range of multicast IP addresses and/or port numbers that are used to select between the BCMCSFlowID-discovery process and the static mapping process. In other words, if the comparison indicates that the multicast IP address and port number fall within the pre-defined range, then the BSN 165 determines to apply the static mapping process. As will be appreciated, one or more pre-defined ranges of multicast IP addresses and/or port numbers can be configured to prompt the static mapping process.

Further, it will be appreciated that each pre-defined range can be used to trigger the same static mapping process, or alternatively can be used to trigger range-specific static mapping processes. For example, different static mapping processes can correspond to different manners by which the multicast IP address and port number are concatenated. In this case, the pre-defined ranges can each be associated with particular static mapping procedures.

In a further example, assume that a given pre-defined range of multicast IP addresses and/or port numbers corresponds to port designation numbers whose 4 LSBs are between [0000] and [1100], and multicast IP addresses whose bit #s 13 . . . 10 correspond to all zeroes. In this case, the BSN 165 determines to apply the static mapping process if the multicast IP address and port designation numbers fall within the above-noted pre-defined range in 810. Alternatively, if the multicast IP address and port number do not fall within one of the pre-defined ranges configured to prompt the static mapping process, the BSN 165 determines not to apply the static mapping process in 810.

As will be appreciated, for convenience of explanation, the preceding example is provided with a number of assumptions that are not necessarily present in each embodiment of FIG. 8. For example, the pre-defined range(s) could be established to encompass any multicast IP address and port designation number pairing, such that the determination of 810 would either evaluate to always-apply static mapping process or to always-apply BCMCSFlowID-discovery process, depending on the implementation.

Further, while FIG. 8 is illustrated as if the multicast IP address and port number are evaluated before the static mapping protocol is applied for BCMCSFlowID generation, in an alternative embodiment the BCMCSFlowID could simply be generated based on the static mapping protocol. Once generated, the BSN 165 could evaluate the BCMCSFlowID to determine whether to use the generated BCMCSFlowID (e.g., by comparing the BCMCSFlowID against a predefined range of BCMCSFlowIDs). In this case, if the BSN 165 determines the BCMCSFlowID should not be used, the generated BCMCSFlowID is dropped and the BSN 165 requests another BCMCSFlowID from the BCMCS controller 180. Thus, the predefined range used to select between static-mapping and BCMCSFlowID discovery need not explicitly be a range of multicast IP addresses and/or port designation numbers, but could rather be a range of BCMCSFlowIDs (although these BCMCSFlowIDs are generated based on the associated multicast IP address and port designation number).

Referring to FIG. 8, if the BSN 165 determines to apply the static mapping protocol for BCMCSFlowID generation in 810, the process advances to 505 of FIG. 5 where the BSN 165 generates the BCMCSFlowID based on the multicast IP address and port designation number for the multicast group. Alternatively, if the BSN 165 determines not to apply the static mapping protocol for BCMCSFlowID generation in 810, the process advances to 815. Although not shown in FIG. 8, in an example, the BSN 165 can simply drop the multicast packet if it determines not to apply the static mapping yet no BCMCS registrations have been received from any of the ATs.

In 815, the BSN 165 sends a BCMCS information request message (“BCMCS_Info_Request”) to the BCMCS controller 180. The BCMCS_Info_Request message contains the multicast IP address/port combinations for each multicast group for which a BCMCSFlowID is being requested. The BCMCS controller 180 retrieves information on the relative priority of the forward link streams, and the BCMCS controller 180 then sends a BCMCS information response message (“BCMCS_Info_Response”) to the BSN 165, 820, which contains mobile security parameters and BCMCS flow identifier(s) for each multicast group identified by the BCMCS_Info_Request. The BSN 165 decodes the BCMCS_Info_Response message received from the BCMCS controller 180 in 825, and extracts one or more BCMCSFlowIDs associated with the multicast group. After obtaining the BCMCSFlowID for the multicast group in 825, the process advances to 510 of FIG. 5, where the BSN 165 sends the multicast message (e.g., announce message) to the RAN 120 along with the discovered BCMCSFlowID.

FIG. 9 illustrates a selective application of a ‘static’ mapping protocol for BCMCSFlowID generation at an AT in accordance with an embodiment of the present invention. Referring to FIG. 9, a given AT determines whether to acquire a BCMCSFlowID for a particular PTT session or multicast session (e.g., in order to send a BCMCSFlowRegistration message to register for a multicast or PTT session). If the given AT determines to acquire the BCMCSFlowID, the given AT analyzes the multicast IP address and/or port number to determine whether to apply the static mapping process or alternatively whether to query the BCMCS controller 180 for obtaining the BCMCSFlowID for the multicast session, 905. In FIG. 9, 905 generally corresponds to 805 of FIG. 8, and thereby will not be described further for the sake of brevity.

Referring to FIG. 9, based on the analysis from 905, the AT determines whether to obtain the BCMCSFlowID via the static mapping process or the discovery process. Accordingly, if the AT determines to apply the static mapping protocol for BCMCSFlowID generation in 910, the process advances to 605 of FIG. 6 where the AT generates the BCMCSFlowID based on the multicast IP address and port number for the multicast group. Alternatively, if the AT determines not to apply the static mapping protocol for BCMCSFlowID generation in 910, the process advances to 405 of FIG. 4 whereby the AT performs a BCMCSFlowID discovery process with the BCMCS controller 180 to obtain the BCMCSFlowID.

Accordingly, FIGS. 8 and 9 illustrate embodiments wherein a hybrid or selective approach is used such that the AT or BSN 165 can acquire BCMCSFlowIDs in different manners depending on the multicast IP address and/or port number for the multicast group. This BCMCSFlowID is then conveyed to the RAN 120, either in the message of 510 of FIG. 5 or a BCMCSFlowRegistration message from the AT.

As will be appreciated, the BCMCSFlowID for the multicast session is only one parameter the RAN 120 must determine to support the multicast session. Other parameters for supporting the multicast session at the RAN 120 can include a requisite data rate for the session, IM pair repetition interval for the session, encoding and framing rules, etc. In other words, aside from the BCMCSFlowID for identifying session-related messages to multicast group members, the RAN 120 also requires session parameters related to BCMCS resources for the multicast session to be supported.

Conventionally, after receiving a message requesting that the RAN 120 announce a multicast session, the RAN 120 will query the BCMCS controller 180 to obtain the session parameters for the multicast session. As will be appreciated, queries between the RAN 120 and BCMCS controller 180 can increase delays during set-up of the multicast session.

Another approach to obtaining session-parameters for the multicast session at the RAN 120 can include the RAN 120 storing a look-up table that includes pre-defined sets of session-parameters that are stored in association with one or more BCMCSFlowIDs. Accordingly, when the RAN 120 is requested to set-up a multicast session for a particular BCMCSFlowID, the RAN 120 can bypass the session-parameter query to the BCMCS controller 180 and instead can simply load the session-parameters associated with the particular BCMCSFlowID in the look-up table.

Yet another approach, described below with respect to FIG. 10, is a hybrid-approach whereby the RAN 120 can select between querying the BCMCS controller 180 and using the look-up table maintained at the RAN 120 for obtaining the session-parameters.

Referring to FIG. 10, the RAN 120 receives a message including a BCMCSFIowID associated with a multicast session being set-up by the RAN 120, 1000. For example, the message received at the RAN 120 in 1000 can correspond to a BCMCSFlowRegistration message received from an AT in 610 of FIG. 6, or alternatively to a request to announce the multicast session received from the BSN 165 in 510 of FIG. 5,.

Next, the RAN 120 analyzes the BCMCSFlowID in the message from 1000 to determine whether to load pre-defined session parameters for the multicast session, or alternatively whether to query the BCMCS controller 180 for the session parameters. For example, the analysis of 1005 can include comparing a given set of bits or ‘prefix’ in the BCMCSFIowID with a set of pre-defined bits that are used to select between (i) loading a set of pre-defined session parameters for the multicast communication session and (ii) querying the BCMCS controller 180 for a set of session parameters for the multicast communication session. For example, the given set of bits or prefix analyzed by the RAN 120 in 1005 can correspond to the bits of the prefix that are inserted into the BCMCSFlowID in 715 of FIG. 7, which can occur either at the BSN 165 or an AT being served by the RAN 120.

As will be appreciated, one or more prefixes can be configured to trigger a loading of one or more sets of pre-defined session parameters. In other words, each prefix can be used to trigger the same session parameters, or alternatively different prefixes can be used to trigger different prefix-specific session parameters. For example, different session parameters can be associated with different multicast sessions, such that certain multicast sessions of a high priority are granted more aggressive or higher-performance session parameters than other multicast sessions, for instance.

In a further example, assume that the set of pre-defined bits to be evaluated against the set of prefixes correspond to the four most significant bits (MSBs) of the BCMCSFlowID and that the set of prefixes configured to trigger the loading of a particular set of pre-defined session parameters include [(0001), (0010), (0100),(1000)]. Accordingly, if the bit-values of the four MSBs of the BCMCSFlowID equal one of the above-noted prefixes, the RAN 120 determines to load a particular set of pre-defined session parameters that are associated with the matching prefix. Alternatively, if the bit-values of the four MSBs of the BCMCSFlowID do not equal one of the prefixes configured to load a set of pre-defined session parameters, the RAN 120 determines not to load a set of pre-defined session parameters for the multicast session in 1010. While the above-example describes the set of prefixes that trigger the loading of pre-defined session parameters as an enumerated set of particular prefixes, it will be appreciated that the set of prefixes could alternatively be configured as a pre-defined range of prefixes that trigger the loading of pre-defined session parameters.

Referring to FIG. 10, if the RAN 120 determines to load a set of pre-defined session parameters for the multicast session in 1010, the RAN 120 loads the set of pre-defined session parameters that is associated with the matching prefix for the multicast session, 1015, after which the process advances to 1030. Alternatively, if the RAN 120 determines not to load a pre-defined set of session parameters for the multicast session in 1010, the RAN 120 sends a request for session parameters of the multicast session to the BCMCS controller 180, 1020. The BCMCS controller 180 sends the session parameters of the multicast session back to the RAN 120 responsive to the request, 1025. In 1030, the RAN 120 applies the session parameters (e.g., loaded in 1015 or received at 1025) during the multicast session with the AT, 1030.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of setting up a given multicast communication session within a wireless communications system, comprising:
determining to obtain a multicast flow identifier for a given multicast communication session, the multicast flow identifier configured to distinguish between communication flows carried by an access network within at least one sector of the wireless communications network;
evaluating one or more multicast communication session identifiers of the given multicast communication session;
selecting, based on the evaluation, one of (i) querying a remote server for the multicast flow identifier, and (ii) applying a pre-defined mapping protocol to the one or more multicast communication session identifiers to generate the multicast flow identifier; and
obtaining the multicast flow identifier in accordance with the selection.

2. The method of claim 1, wherein the evaluating step includes comparing the one or more multicast communication session identifiers with a pre-defined range of the one or more multicast communication session identifiers.

3. The method of claim 2,
wherein the selecting step selects (i) querying the remote server for the multicast flow identifier if the comparison indicates that the one or more multicast communication session identifiers are not within the pre-defined range,
and wherein the selecting step selects (ii) applying the pre-defined mapping protocol if the comparison indicates that the one or more multicast communication session identifiers are within the pre-defined range.

4. The method of claim 1, wherein, if the selecting step selects (i) querying the remote server for the multicast flow identifier, the obtaining step includes:
sending a query for the multicast flow identifier to the remote server; and
receiving the multicast flow identifier from the remote server in response to the query.

5. The method of claim 1, wherein, if the selecting step selects (ii) applying the pre-defined mapping protocol, the obtaining step includes:
generating the multicast flow identifier by concatenating the one or more multicast communication session identifiers and adding a prefix having a given bit-length to the concatenated multicast communication session identifiers,
wherein the prefix is configured to notify the access network that the generated multicast flow identifier was generated in accordance with the pre-defined mapping protocol.

6. The method of claim 1, wherein the one or more multicast communication session identifiers includes a multicast Internet Protocol (IP) address and a port designation number.

7. The method of claim 6, wherein the prefix corresponds to (i) a portion of the multicast IP address and/or port designation number, or (ii) is generated independently of the multicast IP address and port designation number.

8. The method of claim 1, wherein the remote server correspond to a broadcast-multicast service (BCMCS) controller.

9. The method of claim 1, wherein the determining, evaluating, selecting and obtaining steps each occur at a broadcast serving node (BSN).

10. The method of claim 1, wherein the determining, evaluating, selecting and obtaining steps each occur at an access terminal.

11. A method of setting up a given multicast communication session within a wireless communications system, comprising:
evaluating a multicast flow identifier of a given multicast communication session, the multicast flow identifier configured to distinguish between communication flows carried by an access network within at least one sector of the wireless communications network;
selecting, based on the evaluation, one of (i) querying a remote server to obtain a set of session parameters for the given multicast communication session, and (ii) loading a set of pre-defined session parameters for the given multicast communication session; and
obtaining the session parameters for the multicast communication session in accordance with the selection.

12. The method of claim 11,
wherein the evaluating step compares a given set of bits included in the multicast flow identifier with a set of pre-defined prefixes.

13. The method of claim 12,
wherein the selecting step selects (i) querying a remote server to obtain the set of session parameters for the given multicast communication session if the comparison indicates the given set of bits do not match one of the pre-defined prefixes in the set,
and wherein the selecting step selects (ii) loading the set of pre-defined session parameters for the given multicast communication session if the comparison indicates the given set of bits do not match one of the pre-defined prefixes in the set.

14. The method of claim 12, wherein the set of pre-defined prefixes correspond to bit-settings for the given set of bits that are reserved for multicast flow identifiers generated in accordance with a pre-defined mapping protocol without querying the remote server.

15. The method of claim 11, wherein the multicast flow identifier includes a portion of a multicast Internet Protocol (IP) address of the given multicast communication session, a portion of a port designation number of the given multicast communication session and a prefix portion.

16. The method of claim 11, wherein the remote server correspond to a broadcast-multicast service (BCMCS) controller.

17. The method of claim 11, wherein the evaluating, selecting and obtaining steps are performed at the access network.

18. The method of claim 11, wherein the session parameters include one or more of a data rate for the given multicast communication session, Interlace-Multiplex (IM) pair repetition interval for the given multicast communication session and/or encoding and framing rules for the given multicast communication session.

19. A method of generating a multicast flow identifier that is configured to distinguish between communication flows carried by an access network within at least one sector of the wireless communications system, comprising:
acquiring a first multicast communication session identifier of a first type, the first multicast communication session identifier including a given portion that is used at least in part to identify a given multicast communication session;
acquiring a second multicast communication session identifier of a second type, the second multicast communication session identifier including a given portion that is used at least in part to identify the given multicast communication session;
acquiring a pre-defined prefix; and
applying a pre-defined mapping protocol to (i) the given portion of the first multicast communication session identifier, (ii) the given portion of the second multicast identifier and (iii) the pre-defined prefix in order to generate the multicast flow identifier,
wherein the pre-defined prefix is configured to notify the access network that the generated multicast flow identifier was generated in accordance with the pre-defined mapping protocol.

20. The method of claim 19, wherein the acquiring steps and the applying step are each performed at an access terminal.

21. The method of claim 20, further comprising:
configuring a registration message to include the generated multicast flow identifier, the configured registration message requesting registration to the given multicast communication session; and
sending the configured registration message to the access network.

22. The method of claim 21, wherein the multicast flow identifier is a broadcast-multicast service (BCMCS) Flow Identifier (ID), and the configured registration message is a BCMCSFlowRegistration message.

23. The method of claim 19, wherein the acquiring steps and the applying step are each performed at a broadcast serving node (BSN).

24. The method of claim 23, further comprising:
configuring a multicast message for transmission by the access network to include the generated multicast flow identifier; and
sending the configured multicast message to the access network.

25. The method of claim 19, wherein the multicast flow identifier is a broadcast-multicast service (BCMCS) Flow Identifier (ID).

26. The method of claim 19, wherein the acquiring the pre-defined prefix step includes extracting a portion of the multicast IP address and/or port designation number to generate the pre-defined prefix.

27. The method of claim 19, wherein the acquiring the pre-defined prefix step includes generating the pre-defined prefix independently of the multicast IP address and port designation number.

28. A network communication entity configured to set-up a given multicast communication session within a wireless communications system, comprising:
means for determining to obtain a multicast flow identifier for a given multicast communication session, the multicast flow identifier configured to distinguish between communication flows carried by an access network within at least one sector of the wireless communications network;
means for evaluating one or more multicast communication session identifiers of the given multicast communication session;
means for selecting, based on the evaluation, one of (i) querying a remote server for the multicast flow identifier, and (ii) applying a pre-defined mapping protocol to the one or more multicast communication session identifiers to generate the multicast flow identifier; and
means for obtaining the multicast flow identifier in accordance with the selection.

29. The network communication entity of claim 28, wherein the network communication entity corresponds to a broadcast serving node (BSN) or an access terminal (AT).

30. A network communication entity configured to set-up a given multicast communication session within a wireless communications system, comprising:
means for evaluating a multicast flow identifier of a given multicast communication session, the multicast flow identifier configured to distinguish between communication flows carried by an access network within at least one sector of the wireless communications network;
means for selecting, based on the evaluation, one of (i) querying a remote server to obtain a set of session parameters for the given multicast communication session, and (ii) loading a set of pre-defined session parameters for the given multicast communication session; and
means for obtaining the session parameters for the multicast communication session in accordance with the selection.

31. The network communication entity of claim 30, wherein the network communication entity corresponds to the access network.

32. A network communication entity configured to generate a multicast flow identifier that is distinguishes between communication flows carried by an access network within at least one sector of the wireless communications system, comprising
means for acquiring a first multicast communication session identifier of a first type, the first multicast communication session identifier including a given portion that is used at least in part to identify a given multicast communication session;
means for acquiring a second multicast communication session identifier of a second type, the second multicast communication session identifier including a given portion that is used at least in part to identify the given multicast communication session;
means for acquiring a pre-defined prefix; and
means for applying a pre-defined mapping protocol to (i) the given portion of the first multicast communication session identifier, (ii) the given portion of the second multicast identifier and (iii) the pre-defined prefix in order to generate the multicast flow identifier,
wherein the pre-defined prefix is configured to notify the access network that the generated multicast flow identifier was generated in accordance with the pre-defined mapping protocol.

33. The network communication entity of claim 32, wherein the network communication entity corresponds to the access network.

34. A network communication entity configured to set-up a given multicast communication session within a wireless communications system, comprising:
logic configured to determine to obtain a multicast flow identifier for a given multicast communication session, the multicast flow identifier configured to distinguish between communication flows carried by an access network within at least one sector of the wireless communications network;
logic configured to evaluate one or more multicast communication session identifiers of the given multicast communication session;
logic configured to select, based on the evaluation, one of (i) querying a remote server for the multicast flow identifier, and (ii) applying a pre-defined mapping protocol to the one or more multicast communication session identifiers to generate the multicast flow identifier; and
logic configured to obtain the multicast flow identifier in accordance with the selection.

35. The network communication entity of claim 34, wherein the network communication entity corresponds to a broadcast serving node (BSN) or an access terminal (AT).

36. A network communication entity configured to set-up a given multicast communication session within a wireless communications system, comprising:
logic configured to evaluate a multicast flow identifier of a given multicast communication session, the multicast flow identifier configured to distinguish between communication flows carried by an access network within at least one sector of the wireless communications network;
logic configured to select, based on the evaluation, one of (i) querying a remote server to obtain a set of session parameters for the given multicast communication session, and (ii) loading a set of pre-defined session parameters for the given multicast communication session; and
logic configured to obtain the session parameters for the multicast communication session in accordance with the selection.

37. The network communication entity of claim 36, wherein the network communication entity corresponds to the access network.

38. A network communication entity configured to generate a multicast flow identifier that is distinguishes between communication flows carried by an access network within at least one sector of the wireless communications system, comprising
logic configured to acquire a first multicast communication session identifier of a first type, the first multicast communication session identifier including a given portion that is used at least in part to identify a given multicast communication session;
logic configured to acquire a second multicast communication session identifier of a second type, the second multicast communication session identifier including a given portion that is used at least in part to identify the given multicast communication session;
logic configured to acquire a pre-defined prefix; and
logic configured to apply a pre-defined mapping protocol to (i) the given portion of the first multicast communication session identifier, (ii) the given portion of the second multicast identifier and (iii) the pre-defined prefix in order to generate the multicast flow identifier,
wherein the pre-defined prefix is configured to notify the access network that the generated multicast flow identifier was generated in accordance with the pre-defined mapping protocol.

39. The network communication entity of claim 38, wherein the network communication entity corresponds to the access network.

40. A computer-readable storage medium comprising instructions, which, when executed by a network communication entity configured to set-up a given multicast communication session within a wireless communications system, cause the network communication entity to perform operations, the instructions comprising:
program code to determine to obtain a multicast flow identifier for a given multicast communication session, the multicast flow identifier configured to distinguish between communication flows carried by an access network within at least one sector of the wireless communications network;
program code to evaluate one or more multicast communication session identifiers of the given multicast communication session;
program code to select, based on the evaluation, one of (i) querying a remote server for the multicast flow identifier, and (ii) applying a pre-defined mapping protocol to the one or more multicast communication session identifiers to generate the multicast flow identifier; and
program code to obtain the multicast flow identifier in accordance with the selection.

41. The computer-readable storage medium of claim 40, wherein the network communication entity corresponds to a broadcast serving node (BSN) or an access terminal (AT).

42. A computer-readable storage medium comprising instructions, which, when executed by a network communication entity configured to set-up a given multicast communication session within a wireless communications system, cause the network communication entity to perform operations, the instructions comprising:
program code to evaluate a multicast flow identifier of a given multicast communication session, the multicast flow identifier configured to distinguish between communication flows carried by an access network within at least one sector of the wireless communications network;
program code to select, based on the evaluation, one of (i) querying a remote server to obtain a set of session parameters for the given multicast communication session, and (ii) loading a set of pre-defined session parameters for the given multicast communication session; and
program code to obtain the session parameters for the multicast communication session in accordance with the selection.

43. The computer-readable storage medium of claim 42, wherein the network communication entity corresponds to the access network.

44. A computer-readable storage medium comprising instructions, which, when executed by a network communication entity configured to set-up a given multicast communication session within a wireless communications system, cause the network communication entity to perform operations, the instructions comprising:
program code to acquire a first multicast communication session identifier of a first type, the first multicast communication session identifier including a given portion that is used at least in part to identify a given multicast communication session;
program code to acquire a second multicast communication session identifier of a second type, the second multicast communication session identifier including a given portion that is used at least in part to identify the given multicast communication session;
program code to acquire a pre-defined prefix; and
program code to apply a pre-defined mapping protocol to (i) the given portion of the first multicast communication session identifier, (ii) the given portion of the second multicast identifier and (iii) the pre-defined prefix in order to generate the multicast flow identifier,
wherein the pre-defined prefix is configured to notify the access network that the generated multicast flow identifier was generated in accordance with the pre-defined mapping protocol.

45. The computer-readable storage medium of claim 44, wherein the network communication entity corresponds to the access network.
